(19) United States
(12) Patent Application Publication
(10) Pub. No.: US 2010/0112164 A1
(43) Pub. Date: May 6, 2010

(54) METHOD AND APPARATUS FOR BREWING BEVERAGES

(76) Inventor: Robert C. Taylor, Gahanna, OH (US)

Correspondence Address: BRUCE E. WEIR, 12 SPARROW VALLEY COURT, MONTGOMERY VILLAGE, MD, 20886-1265, US

(21) Appl. No.: 12/261,782

(22) Filed: Oct. 30, 2008

(51) Int. Cl. A47J 31/02; B65D 85/00

(52) U.S. Cl. 426/432; 99/323; 99/306; 206/217

(57) ABSTRACT

A portable kit for brewing beverages has a brace the rests atop a drinking cup, a tubular riser that rests atop the brace, a bottom ring with a folding handle, one or more reuseable or disposable filters, one of which is secured to the bottom ring by a top ring, and a sprinkler with a hemispherical reservoir that is penetrated by tubes that evenly distribute fluid from the reservoir into the filter. When beverage material is placed in the filter, fluids poured into the sprinkler pass through the beverage material and the filter and collect in the drinking cup. Alternately, the bottom ring may rest directly on the drinking cup with the filter extending into the drinking cup so that a steeped beverage may be brewed. The components may be disassembled and carried in a small pouch.

### BACKGROUND

Brewed beverages such as coffee and tea are consumed daily by millions of people all over the globe. Most prefer a freshly-brewed beverage. Many consume their beverage of choice while at work or in some location where the means to brew a beverage is limited or non-existent. While instant beverages are available, some, such as instant coffee, are widely considered to be inferior in taste to the same beverage freshly-brewed from raw beverage material.

Many work environments and public accommodations offer an electric device that brews a quantity of coffee in a pot. The communal coffee pot quickly develops a characteristic scorched taste and is the perennial butt of much office humor. Over time, accreted mineral and coffee residue add to the offensiveness of the brew. A pot of coffee is far too much for most drinkers to consume in a short time. Espresso machines and other electric devices for brewing small quantities are expensive and impractical to transport. A few devotees carry pre-ground coffee and a French press, but these presses are generally made of glass and have a disconcerting tendency to transform themselves into piles of shards at the bottom of a purse or briefcase.

A user's choice of brewing system limits the user's ability to vary the type and the potency of their brew. Coffee brewing systems are usually unsuitable for brewing tea; tea brewing systems are usually unsuitable for brewing coffee. Drip systems tend to require more beverage material to increase potency, increasing the cost of the resulting beverage. Steeping systems tend to require longer brewing duration to increase potency, often increasing the acidity of the resulting beverage. In either case, most brewing systems are too heavy and bulky to transport conveniently.

What is needed is a single compact, easily-carried, inexpensive, reusable system for on-the-spot brewing of beverages from fresh beverage materials. Such a system should be easily reconfigured to drip-brew or steep, as desired, and to provide control over the potency of the brew without requiring additional brewing material or brewing time.

### SUMMARY

Embodiments of the invention provide means for brewing coffee, tea, and other beverages in single cup quantities. A filter is secured onto a bottom ring with a top ring. Beverage material is placed in the filter. In one embodiment the bottom ring may rest on a riser that in turn rests on a brace supported by a beverage cup. A sprinkler is placed on the top ring and fluids poured through the sprinkler pass through the beverage material into the cup, with the beverage material held above the cup by the riser. In another embodiment the bottom ring is placed directly on the rim of the cup with the filter resting at least partially within the cup, allowing a user to steep beverage material within the cup.

All components may be made from microwave-oven-safe material. An embodiment of the invention may comprise a kit with the brace, riser, bottom ring, top ring, sprinkler, extra filters, packages of beverage material, and a portable coffee grinder, all contained within a convenient carrying pouch. All of these features and advantages, and more, are illustrated below in the drawings and detailed description that follow.

### BRIEF DESCRIPTION OF THE DRAWINGS

FIG. 1 shows an exploded perspective view of a beverage brewing apparatus.

FIG. 2 shows a top plan view of a sprinkler.

FIG. 3 shows a top perspective view of a top ring.

FIG. 4 shows a top plan view of a top ring.

FIG. 5 shows a top plan view of a top ring with an installed sprinkler.

FIG. 6 shows a bottom perspective view of a top ring.

FIG. 7 shows a perspective view of a filter.

FIG. 8 shows a perspective view of a bottom ring.

FIG. 9 shows perspective views of a riser and a brace.

FIG. 10 shows a side elevation view of a brace.

FIG. 11 shows a perspective view of an embodiment of the invention configured to brew tea.

FIG. 12 shows a perspective view of an embodiment of the invention configured to brew coffee.

FIG. 13 shows a perspective view of the top ring, filter, bottom ring, and riser configured for storage.

FIG. 14 shows a perspective view of a pouch for carrying the invention as a kit.

FIG. 15 shows an elevation view of a pre-measured packet of beverage material.

FIG. 16 shows a perspective view of a compact portable coffee grinder.

### DETAILED DESCRIPTION

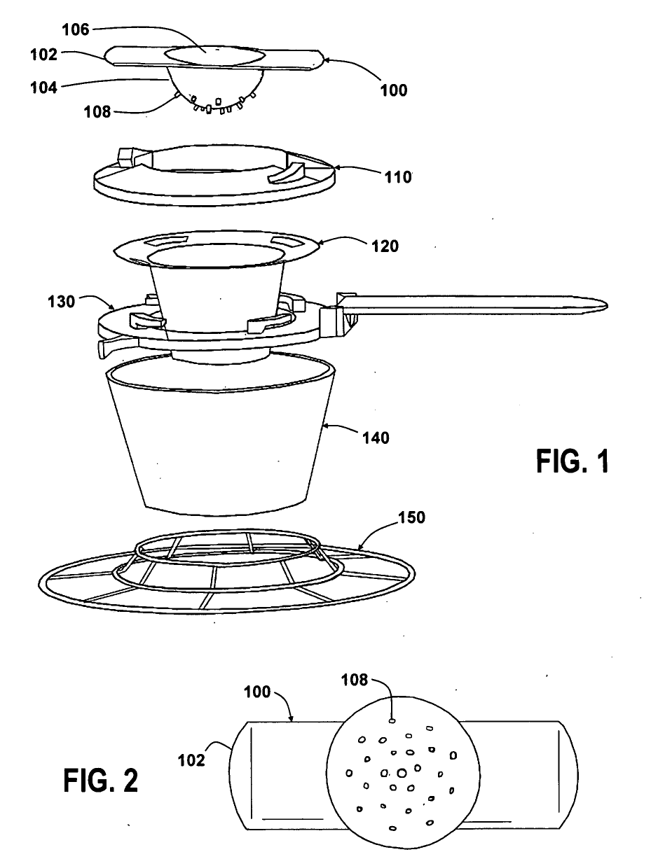

FIG. 1 shows an invention embodiment that includes optional components that improve the performance of the invention while brewing certain beverages. An optional sprinkler 100 rests upon a top ring 110 that secures a filter 120 to a bottom ring 130. In certain embodiments the bottom ring 130 rests upon an optional riser 140 that is in turn supported by an optional brace 150. All components may be readily fabricated from metal, plastic, and other known material using known manufacturing techniques. Certain plastic components offer the advantage of being safe to use in a microwave oven.

The optional sprinkler 100 has a support plate 102 with a hemispherical reservoir 104 mounted in the center. The reservoir 104 protrudes downward with its open side 106 facing upward. A number of tubes 108 are arrayed on and pass through the lower surface of the reservoir 104. Water poured into the reservoir 104 passes slowly through the tubes 108 and is distributed evenly over ground coffee or other beverage material beneath. FIG. 2 shows a top plan view of a sprinkler 100.

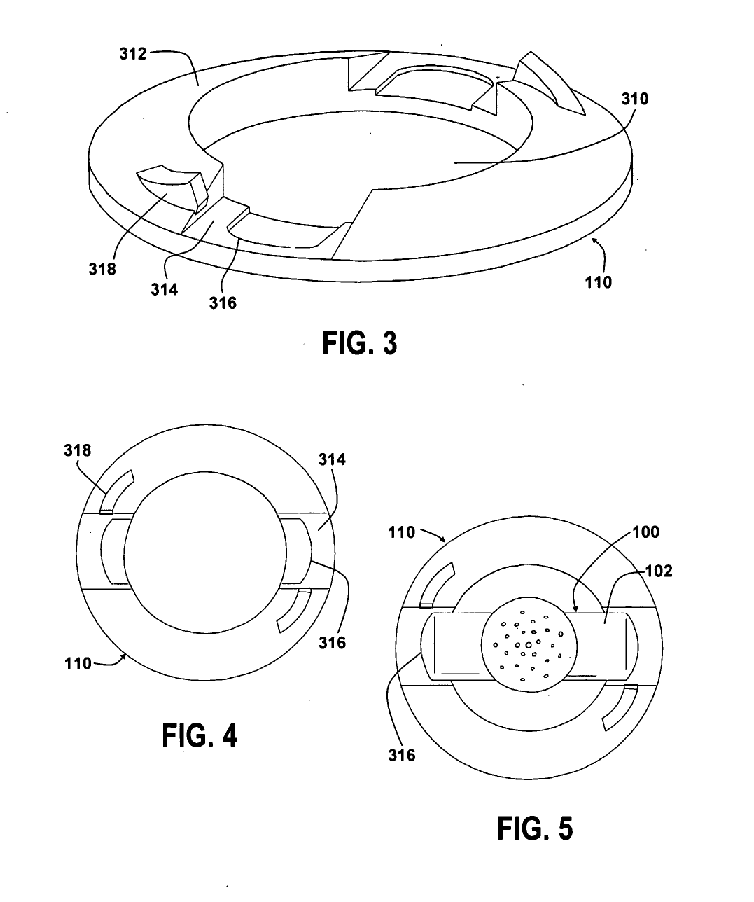

FIG. 3 shows a perspective view of the top ring 110. In a preferred embodiment, a top ring central opening 310 is surrounded by a top ring body 312 with sufficient volume to accommodate locking hooks within. Another embodiment (not shown) may have a thinner ring body with openings to allow locking hooks to pass through the top ring body and lock against its upper surface. Grips 318 allow a user to more easily exert torque on the top ring 110 when the top ring 110 is locked onto or unlocked from the bottom ring 130. FIG. 4 shows a top plan view of the embodiment of FIG. 3.

Returning to the embodiment of FIG. 3, slots 314 in opposite sides of the top ring body 312 allow placement of the optional sprinkler 100 and a folded handle across the top ring 110. Optional shallow recesses 316 are shaped to conform closely to the ends of the support plate 102 to prevent lateral movement of the sprinkler 100, shown spanning the top ring central opening 310 in FIG. 5.

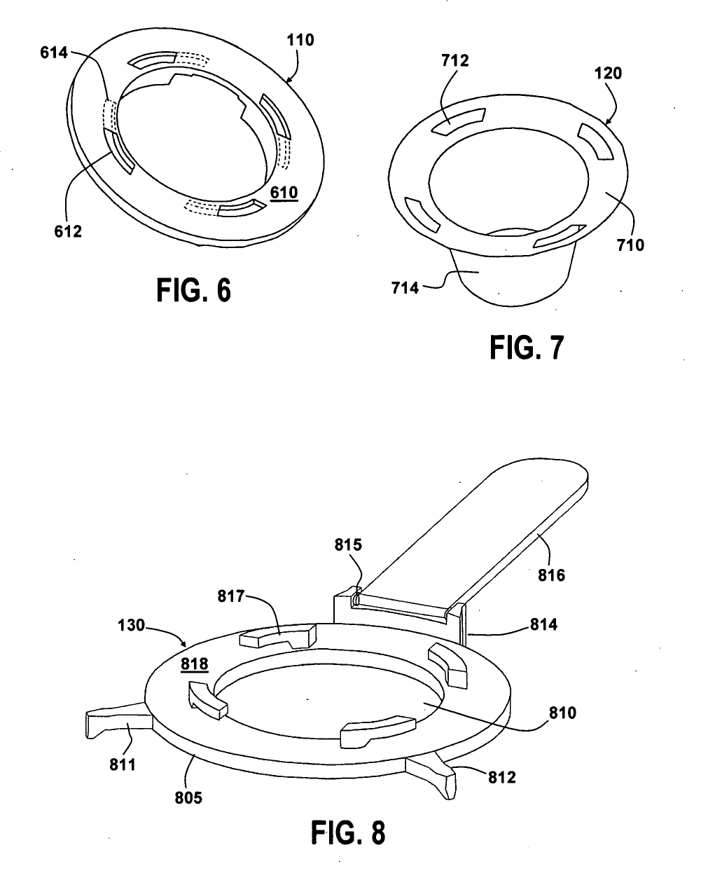

FIG. 6 shows a perspective view of the underside of the top ring 110 of FIG. 3. The flat bottom surface 610 has four slots 612 that accept locking hooks 817 shown in FIG. 8. In the embodiment of FIG. 6 the slots 612 are curved to conform to curved hooks and are formed within the top ring 110. Each slot communicates with an internal cavity 614 that engages a hook 817 when the hook 817 is inserted in the slot 612 and the top ring 110 is rotated to move the hook 817 into the internal cavity 614. Engaging all hooks 817 with all internal cavities 614 locks the top ring 110 to the bottom ring 130.

FIG. 7 shows a filter 120 with a rim 710 and a basket 714. The rim 710 has slots 712 that align with the slots 612 in the top ring and are large enough to fit over the hooks 817. The basket 714 may be made from a fine metal or plastic mesh or from permeable paper, all of which are well-known in the art. Embodiments of the basket 714 may be made of paper or other known materials that may be easily folded or compressed against the rim 710 without damage, greatly reducing the volume of a filter 120 when stored prior to use or discarded after use.

The rim 710 may be stiffened with metal, plastic, paper or other known material, either by use of a different material than is used in the basket, or a thicker layer of the same material as used in the basket, or one or more additional layers of any suitable material. The rim 710 is sized and shaped to fit between and be secured by the top ring 110 and the bottom ring 130 when the top ring 110 is locked to the bottom ring 130.

FIG. 8 shows a perspective view of the bottom ring 130. A bottom ring central opening 810 surrounds a bottom ring body 805 with an upper surface 818, hooks 817 protruding upward from the upper surface 818, support legs 811, 812 and a handle 816 mounted on a hinge 815 atop a hinge extension 814. Although the embodiment of FIG. 8 depicts four hooks, two or three would suffice. The upper surface 818 is sized and shaped to fit closely with the lower surface 610 of the top ring 110 when the top ring 110 is locked to the bottom ring 130. The support legs 811, 812 and hinge extension 814 extend radially from the bottom ring body 805. The hinge extension 814 raises the hinge 815 above the upper surface so that the handle 816 may be folded flat across the top ring 110 when the top ring 110 is locked to the bottom ring 130.

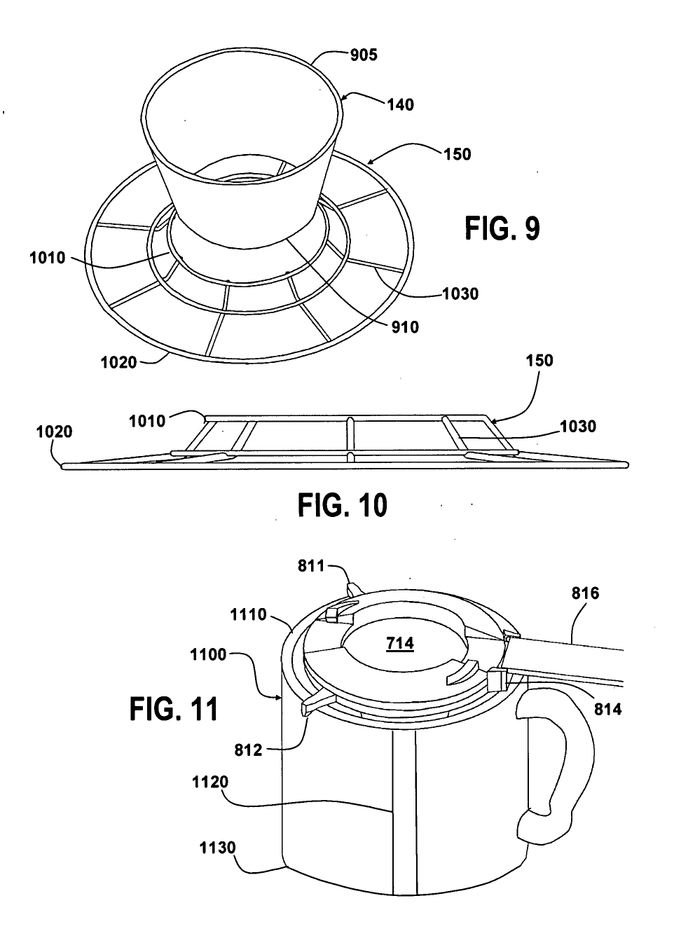

FIG. 9 shows perspective views of a riser 140 and a brace 150. In the embodiment of FIG. 9 the riser 140 is a hollow, inverted conical frustum made of plastic, metal, water-resistant paper, or other known rigid or semi-rigid materials. The brace 150 embodied in FIGS. 9 and 10 is a metal or plastic frame with an inner ring 1010 and an outer ring 1020 concentrically disposed and joined by radial rods 1030. As shown in FIG. 10, the inner ring 1010 may be raised with respect to the outer ring 1020. The diameter of the inner ring 1010 is greater than the diameter of the lower rim 910 of the riser 140 but less than the diameter of the upper rim 905, so that the riser 140 will wedge into a secure position when inserted through the inner ring 1010 of the brace 150.

Depending on configuration, the invention may be advantageously used to steep beverage material directly in hot or cold water or to allow water to seep gradually through the beverage material and collect in a container below. In either case the top ring 110, filter 120, and bottom ring 130 are first assembled in the order shown in FIG. 1. The handle 816 of the bottom ring 130 (FIG. 8) is extended. The slots 712 in the rim 710 of the filter 120 (FIG. 7) are aligned with and pressed down over the hooks 817 of the bottom ring 130 (FIG. 8) until the rim 710 is seated on the upper surface 818 of the bottom ring 130.

With the bottom surface 610 of the top ring 110 (FIG. 6) turned downward and the slots 612 in the top ring 110 aligned with the hooks 817 in the bottom ring 130, the top ring 110 is pressed down onto the hooks 817 until it contacts the rim 710. The top ring 110 is then rotated until the hooks 817 engage the internal cavities 614 and the top ring 110 is secured to the bottom ring 130. Grips 318 (FIG. 3) allow the user to more easily apply torque to the top ring 110 while locking the top ring 110 to or unlocking the top ring 110 from the bottom ring 130.

A beverage that is brewed by steeping beverage material in a fluid may then be created by placing beverage material in the basket 714 and inserting the basket 714 directly into a cup 1100 until the support legs 811, 812 and hinge extension 814 rest on the rim 1110 of the cup as shown in FIG. 11. Hot water or another desired fluid may be present in the cup prior to insertion of the basket 714 or may be poured through the central openings 310, 810 into the basket 714 to collect in the cup 1100.

In an embodiment made from microwave-oven-safe material, cold water may be placed in the cup 1100, the apparatus assembled, filled with beverage material, and inserted in the cup, and the whole assembly heated in a microwave oven. A cup that is transparent or has a vertical transparent band 1120 from base 1130 to rim 1100 can simplify addition of the correct amount of water. The basket 714 and beverage material within may be left immersed for the desired period of time, then the user may grasp the handle and remove the entire assembly from the cup 1100.

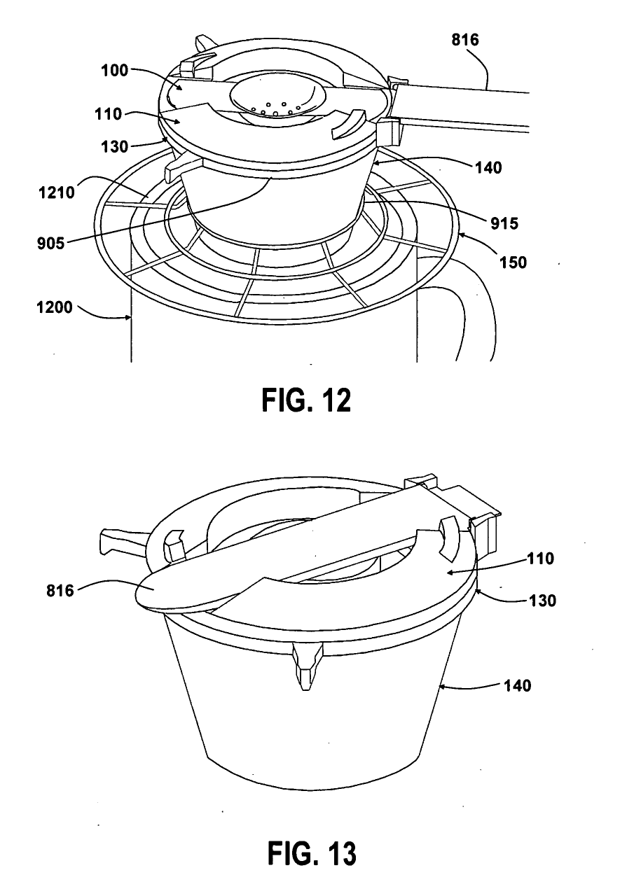

When the user prefers to trickle fluids slowly through the beverage material without allowing the beverage material to sit in the fluids collected in the cup, the riser 140 may be inserted into the inner ring 915 of the brace 150 in the manner shown in FIG. 12. The assembled brace 150 and riser 140 are placed upon the rim 1210 of a cup 1200. The top ring 110, filter 120, and bottom ring 120 are assembled as described above and the handle 816 is extended. The basket 714 is inserted into the riser 140 until the bottom ring 130 rests upon the upper edge 905 of the riser 140. Beverage material may be placed in the basket before or after the basket is inserted into the riser 140. Hot water or another desired fluid may be poured through the central openings 310, 810 into the basket 714 to filter through the beverage material and collect in the cup 1200.

Since the bottom ring and/or basket/riser assembly may cover the mouth of a cup, a cup that is transparent or has a vertical transparent band from base to rim can simplify addition of the correct amount of fluids for any method in which fluids are added after the brewing apparatus is in or on the cup. A transparent vertical band allows the user to use a cup with a desired opaque exterior color or other decoration while easily determining the fluid level in the cup.

Addition of the optional sprinkler 100 slows the introduction of the fluid and improves distribution of fluid over the beverage material, improving the performance of the apparatus when used to make coffee. The sprinkler 100 may be placed upon the top ring 110 as shown in FIG. 5 after assembly of the top ring 110, filter 120, and bottom ring 130 and introduction of beverage material into the filter. Water or another fluid may then be poured through the sprinkler into the beverage material as described above. With or without the sprinkler, the entire assembly may be removed from the cup once the fluid has ceased to drip from the basket.

After use, the apparatus may be disassembled in reverse order of assembly. The top ring may be detached from the bottom ring and the filter either cleaned or replaced. The apparatus may be conveniently stored in the manner shown in FIG. 13 by inserting the filter or filters into the riser 140, reassembling the top 110 and bottom 130 rings, and folding the handle 816 across the sprinkler and the top ring 110.

The invention's ability to function as both a drip system and by steeping beverage material affords additional control over the potency of the resulting brew. For example, stronger coffee may be brewed by steeping coffee grounds instead by drip brewing, reducing or eliminating the need to use extra coffee to make a stronger beverage. Conversely, weaker tea may be brewed with a drip system, eliminating the acidity that may develop when tea is steeped too long.

In a simple embodiment the user may employ only the top ring 110, filter 120, and bottom ring 130 to brew a beverage. When a filter 120 utilizing an easily folded or compressed basket 714 material is chosen for this embodiment, the stored components form a thin, flat, lightweight package that may be easily shipped, distributed, or carried in a pocket or purse.

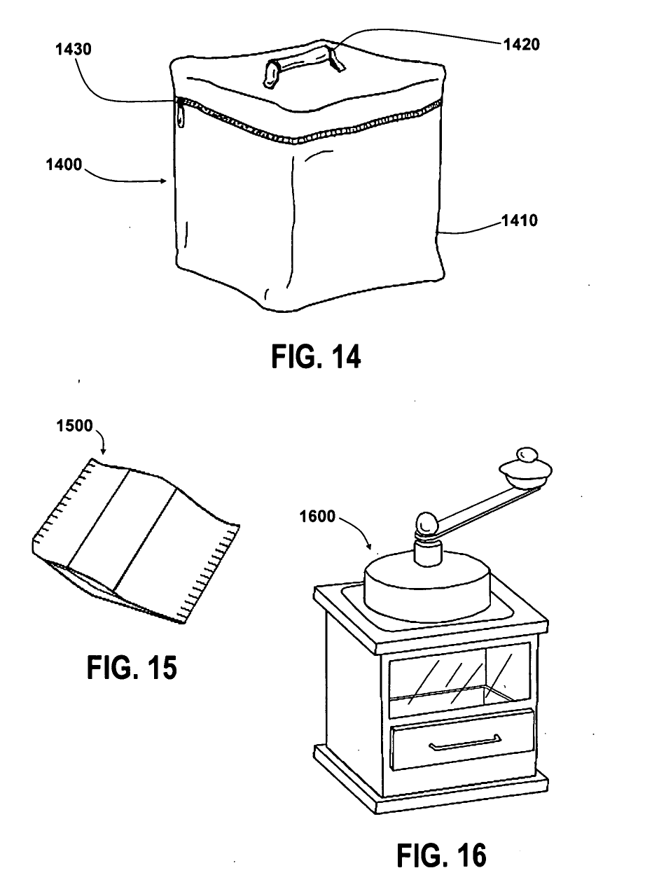

The apparatus may also be stored, carried, and used as a kit comprising the top ring 110, one or more reusable or disposable filters 120, a bottom ring 130, one or more pre-measured packets of beverage material 1500 as shown in FIG. 15, all stored and carried in a pouch. FIG. 14 shows a fabric pouch 1400 with a carry bag 1410, a handle 1420, and an access zipper 1430. Such a pouch may also be equipped with a shoulder strap as is known in the art. The pouch 1400 may vary in size and shape according to the intended contents, mode of transportation, and anticipated circumstances of use. A pouch for a beverage-brewing kit may have internal hook-and-loop or elastic straps to hold kit components in convenient locations. Many versions of suitable storage pouches and premeasured beverage packets, such as coffee packets or tea bags, are well-known in the art.

A more versatile kit could include with the items already described a sprinkler 100, a riser 140, a brace 150, a portable coffee grinder 1600 as shown in FIG. 16, a beverage container such as a cup 1200 or mug, and a portable beverage heater. Compact portable coffee grinders and cups, mugs, and other suitable containers are well-known in the art. Known coil-type, one-cup beverage heaters are often provided by hotels and motels, and may be purchased from vendors of travel gear. The drawings referenced in this specification are not to scale, with the pouch 1400 being large enough to contain all of the items described in this and the preceding paragraph.

A person using the fully equipped kit to brew fresh coffee could remove the contents of the pouch, assemble the brewing apparatus as described above, grind fresh coffee beans with the portable grinder or open a pre-measured packet of ground coffee, place the coffee in the filter, place the sprinkler atop the top ring, place the assembled brewing apparatus on a cup or mug, pour hot water through the sprinkler, wait for the water to pass through the filter, remove the apparatus from the cup or mug, and enjoy a fresh cup of hot coffee. The apparatus may then be disassembled in reverse order of assembly and kit components stored within the pouch. A kit with a beverage heater would allow the user to either pre-heat water for a steeped beverage in the brewing cup or pre-heat water for a non-steeped beverage in a separate cup to be poured into a brewing cup.

The principles, embodiments, and modes of operation of the invention have been set forth in the foregoing specification. The embodiments disclosed herein should be interpreted as illustrating the invention and not as restricting it. The foregoing disclosure is not intended to limit the range of equivalent structure available to a person of ordinary skill in the art in any way, but rather to expand the range of equivalent structures in ways not previously contemplated. Numerous variations and changes can be made to the foregoing illustrative embodiments without departing from the scope and spirit of the invention.

I claim:

1. An apparatus for brewing a beverage, comprising:
a top ring, the top ring having a central opening, a lower surface, and means to engage and lock onto at least two hooks;
a filter, the filter having a rim and a basket, the rim having at least two openings aligned with the top ring means to engage and lock onto hooks, the rim being stiffer than the basket and operable to seat smoothly against the top ring lower surface; the basket being permeable to fluids; and
a bottom ring, the bottom ring having a central opening, an upper surface, at least a first support leg and a second support leg, a hinge extension, and at least two hooks operable to engage the top ring means to engage and lock onto hooks; the first support leg, second support leg, and hinge extension disposed on the perimeter of the bottom ring and operable to support the bottom ring on the rim of an upper opening of a container; the bottom ring upper surface operable to seat smoothly against the underside of the filter rim; the hooks disposed on the upper surface and aligned with the filter openings and the top ring means to engage and lock hooks; the hinge extension having a hinge; a handle rotatably attached to the hinge, the handle operable to extend from the bottom ring, the hinge extension fixing the hinge sufficiently far above the upper surface of the bottom ring to allow the handle to pivot on the hinge to span the top ring when the top ring is locked to the bottom ring.

2. The apparatus claimed in claim 1, further comprising a sprinkler, the sprinkler having a support plate and a reservoir, the reservoir penetrated by a plurality of openings.

3. The apparatus claimed in claim 1, further comprising a riser and a brace, the riser comprising a hollow, inverted conical frustum with an upper rim and a lower rim; the brace having an inner ring and an outer ring, the inner and outer rings concentrically disposed; the diameter of the inner ring being greater than the diameter of the lower rim of the riser but less than the diameter of the upper rim of the riser.

4. A kit for brewing a beverage, comprising:
a sprinkler, the sprinkler having a support plate and a reservoir, the reservoir penetrated by a plurality of openings;
a beverage receptacle, a brace, and a riser, the beverage receptacle having a first upper opening, the riser being a tube with a second upper opening and a first lower opening, the brace operable to rest upon the beverage receptacle first upper opening while supporting the riser first lower opening;
a top ring, at least a first filter, and a bottom ring, the filter having a rim operable to be secured between the top ring and the bottom ring, the top ring operable to be secured onto the bottom ring, the bottom ring operable to rest upon the riser second upper opening with the filter at least partially inserted into the riser;
at least a first package of beverage material; and
a pouch, the pouch operable to contain the disassembled sprinkler, beverage receptacle, brace, riser, top ring, bottom ring, a plurality of filters, and a plurality of packages of beverage material.

5. The kit as claimed in claim 4, further comprising a portable coffee grinder, the pouch operable to additionally contain the coffee grinder.

6. The kit as claimed in claim 4, wherein the beverage receptacle is a cup with a transparent vertical band allowing a user to view the fluid level in the cup.

7. A method for brewing a beverage, comprising:
placing the rim of a filter upon an upper surface of a bottom ring with a basket portion of the filter protruding downward through a central opening of the bottom ring;
securing the filter by locking a top ring onto the bottom ring;
resting a brace atop a beverage drinking receptacle;
resting a riser atop the brace;
resting the bottom ring atop the riser;
placing beverage material inside the filter basket portion;
resting a sprinkler atop the top ring; and
pouring a fluid through the sprinkler until a desired quantity of a beverage has collected in the beverage drinking receptacle.
